(19) United States
(12) Patent Application Publication
(10) Pub. No.: US 2002/0172771 A1
(43) Pub. Date: Nov. 21, 2002

(54) Short dwell time coater and method

(76) Inventor: Wayne A. Damrau, Wisconsin Rapids, WI (US)

Correspondence Address: PYLE & PIONTEK, 221 N. LaSalle Street, Suite 850, Chicago, IL, 60601, US

(21) Appl. No.: 09/859,061

(22) Filed: May 16, 2001

(51) Int. Cl. B05D 3/12

(52) U.S. Cl. 427/355; 427/356; 118/232

(57) ABSTRACT

An improved short dwell type coater and method are provided. The coater can coat a web directly or a moving roll surface as in a film coater or size press. The flow path in the coater includes a flow modifier shaped to have the introduced coating first turn upstream relative to the web or roll surface, then turn across a curved surface toward the web or roll and around the flow modifier. The flow then converges toward the top of the flow modifier and passes the tip of the flow modifier. Some flow remains on the web or roll and is subsequently doctored, while most is turned away from the web or roll and merged with the incoming flow. A gap filled with coating overflow provides a liquid seal. This coater and method use coating, reduce vortices and streaking, and can operate at higher speeds.

This invention relates to paper coating and paper coaters, and more particularly to short dwell time paper coating and short dwell time paper coaters, also referred to as a short dwell time applicator (SDTA). SDTA's are suitable for applying coatings to a moving surface, be it directly on a web or roll, such as a roll in a film coating application. Background of the Invention Short dwell time coaters, SDTA's, and the method were developed by Consolidated Papers, Inc. and are shown in U.S. Pat. No. 4,250,211 and No. 4,512,279, which are herein incorporated by reference. While this coating method and coater have been adopted worldwide, this coating method and coater is subject to developing streaking which shows up on the paper generally at high speeds say at 3500 ft./min. and certainly by 4500 ft./min, depending on coating weight applied, i.e., the higher coating weight the greater the streaking tendency. Much has been written about this streaking and many attribute it to vortices that develop in the coater when it is operated at higher speeds. Much has also been written in attempts to solve this streaking and/or vortices problem. Still others suggest that uneven web wetting when the paper web first enters this type coater also can result in non-uniform coating. Again, various attempts have been made to try to make the coated web streak free and web wetting more uniform.

For example, see U.S. Pat. Nos. 4,369,731; 4,839,201; 4,452,833; 4,780,336; and 4,834,018 and other patents, WO 97/08385 all of which are herein incorporated by reference. Also see the Eklund and Norrdahl article entitled “The Characteristics of Flow in a Short-Dwell Coater” appearing in the Tappi Journal May 1986, pages 56-58.

### SUMMARY OF THE INVENTION

The coater and method of the present invention addresses the foregoing difficulties, particularly at higher web speeds and provide a coating process and coater which directs the coating upward onto the sheet in a uniform manner and provides a flow member or modifier in the application zone of the coater to specially direct the flow about the coater to minimize or eliminate the effect of vortices and streaking.

The coater of the present invention comprises a coating body having an incoming coating supply or metering channel. The body terminates at its upstream end to form an application zone. At the front or upstream side of the coater a spaced gap with a moving surface, be it a web or roll surface, is provided to accommodate coating overflow which functions like the overflow in a short dwell coater to exclude air and helps form a liquid seal. At its downstream end the coater has a doctoring means such as a flexible blade, a bent blade and/or doctor rod, grooved or plain, for doctoring the coating to the desired amount or level on the web or roll surface. As is noted, the coater body forms between its upstream edge (the gap) and downstream edge (the doctor), an application zone. Situated within the application zone is a shaped, streamline flow modifying element or member about which the coating can flow. On the upstream side of the inlet channel, a downstream turn or bend is formed to first direct the flow one direction (opposite the direction of web or roll surface travel) and then another turn or change of direction (upwardly toward the web or roll surface). As shown in FIG. 1, if the upstream side is on the left, the inlet channel first turns to the left then to the right (up) onto the moving surface, be it web or roll. The directing of the flow about the second or upward curve or turn, just before the web or roll, tends to displace any air bubbles in the coating to the inside of the turn, or away from the sheet or roll surface and the upward action or movement of the coating toward the web or roll tends to help insure uniformly wetting of the web or roll surface.

The coating is then further drawn over the top (or supply) side of flow body around the tip by the rapidly moving (3500 feet per minute or more) web or roll surface, and then meets the doctor. The doctor only lets a desired quantity of coating to uniformly pass downstream, which causes much of the coating, preferably a majority, and more preferable several times more coating than is applied to the web, to flow down the downstream (or return) side of the flow modifier. It is believed with this construction the majority of flow is clockwise (as shown in FIG. 1) around the flow modifier element. At the remaining portion or downstream or return side of the flow modifier element, the downwardly flowing coating which is given velocity and momentum by the moving web or roll surface, merges with the newly introduced coating moving from the inlet channel toward the application zone. Preferably, the distance between the downstream side of the coater body forming the gap and the upstream side of the flow modifier is adjustable to help set up the desired flow ratios and gap for the liquid seal in the gap and to insure a metering gap just before the coating leaves the metering slot, starts to flow around the modifier and approaches the moving web or roll surface. Further, the flow passages and flow member are shaped to cause the flow to be restricted or metered as discussed, to provide more uniform cross web distribution of the coating, and to minimize the total amount of newly introduced coating needed to meet the coater's flow requirement. To effect this, narrowing, tapering surfaces toward the downstream direction are provided. It is believed that with the present invention the amount of coating supplied can be reduced 32-54% as compared to a conventional SDTA coater, like that shown in the 4,250,211 patent. For example, a conventional SDTA may need 2.2 gallons of coating supplied per minute per inch of width, while with the present invention that could be reduced to 1.0 to 1.5 gallons per minute per inch of width. With an application zone length of about 2.5 inches and dwell times of 0.0100 to 0.0016 seconds, this represents a web or roll surface speed of 1250 to about 7800 feet per minute (fpm). This is a good operating range for the invention when it is incorporated in size press, film coater or web coating applications. Typical operating ranges for a size press or size press process is 1000 to 6500 fpm, film coater or film coater process is 1000 to 6500 fpm, and direct web coater or coating process is 1000 to 8125 fpm. The advantage of the present invention is its broad operating range from low speed to very high speeds. This is unlike the prior SDTA applicator which is not suitable for such high speeds because of vortices and/or streaking.

### OBJECTS OF THE PRESENT INVENTION

It is an object of the present invention to provide a coater and coating method which operates at high speeds, while minimizing or eliminating streaking the paper web.

Another object of the present invention is to provide a coater and coating method which minimizes the effects of vortices, but minimizes total coating flow required.

Yet another object of the present invention is to provide a short dwell time coater and method which minimizes vortices and/or eliminates or diminishes streaking.

A still further object of the present invention is to provide a coater and coating method which utilizes a flow modifier element or member to cause a smooth, uniform flow to minimize streaking and/or vortices formation.

Yet a further object of the present invention is to cause the coating to first move downstream and then curve or turn toward the web before entering the application zone.

Still a further object of the present invention is to provide narrowing, tapering surfaces to provide uniform cross web coating distribution.

Still a further object is to provide a coater or method for use in coating a moving web or a roll of a film coater or size press.

A further object is to provide a coater of the present invention which can directly coat paper and/or indirectly coat paper when such coater is provided as part of a film coater or size press.

These and other objects of the present invention will become apparent from the following written description and accompanying figures of the drawings.

### DESCRIPTION OF THE DRAWINGS

FIG. 1 is a cross sectional view of a coater of the present invention and illustrates the method of the present invention and the flow paths of the coating within the coater.

FIG. 2 is a sectional view taken along the line 2-2 of FIG. 1, illustrating how the coating can flow around the flow modifying element or member and one way that element can be mounted in the coater.

FIG. 3 is a view of the coater of the present invention incorporated into a film coater having a moving roll surface which receives the coating and in turn transfers the coating to a moving web.

### DESCRIPTION OF THE PREFERRED EMBODIMENT

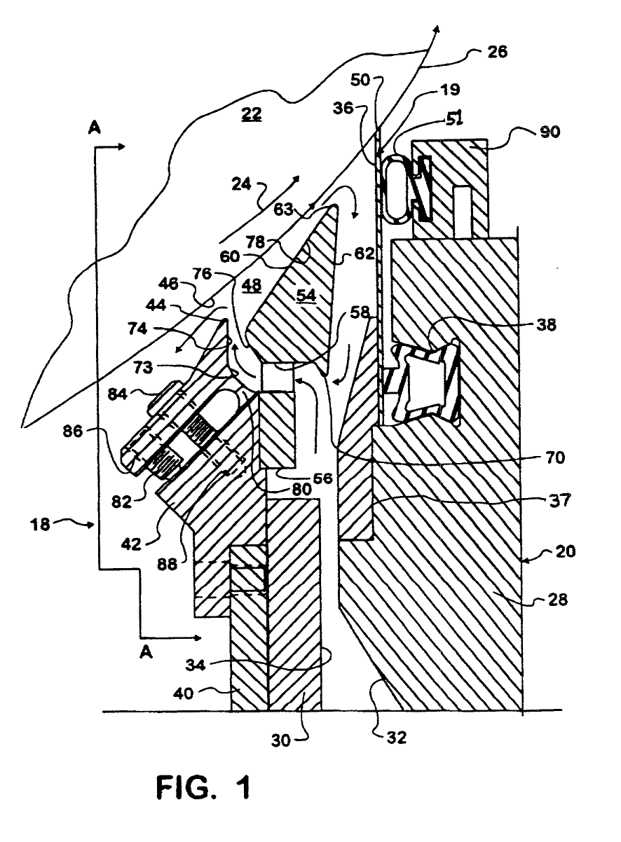

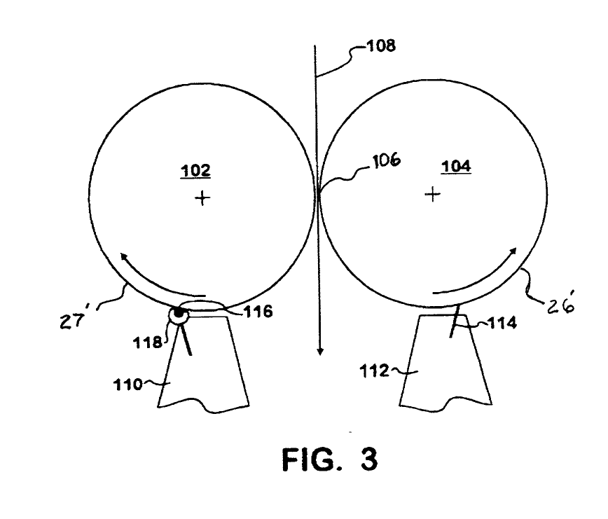

Referring to the drawings, there is shown in FIG. 1 an applicator or coater portion 18 of a paper coating machine, having a leveling doctor 19. The applicator 18 is carried on a main beam indicated generally at 20, extending parallel to and coextensively with a rotatable or movable support or backing roll 22 which rotates in the direction shown by an arrow 24 and supports a moving surface, in this instance, a web of paper 26, during its travel through an application zone. As noted in FIG. 3, the applicator or coater can also apply coating to a moving roll surface 26′ or 27′, and from there to a web 108 in a film coating application. Referring back to FIG. 1, the beam 20 has rear and front wall members 28 and 30 forming a chamber 32 therebetween for reception of liquid coating material under pressure from a source of material (not shown), and the walls 28 and 30 converge upwardly toward one another and define a first metering slot 34 which extends upwardly adjacent to and facing the web 26 and support surface of the roll 22. Although not shown, the front wall 30 may be or otherwise, pivotally mounted relative to the rear wall 28 to permit the chamber 32 to be opened for cleaning and also to adjust the width of the metering slot 34.

A doctor in the form of a roll or, in this instance, a coater blade 36 is mounted at the downstream end of the application zone. The application zone is about 2.5 inches in length along the circumference of the roll or web surface. In this instance, the flexible blade 36 is held against a rearward surface 37 on the rear wall 28 by a pneumatic tube 38 which is expandable by the introduction of fluid or air under pressure therein to press against the blade. The coater doctor blade extends above the metering slot 34 into engagement with the web supported on the roll 22 and serves to meter and level the coating applied onto the surface of the web, or in case of film coating on a size press, onto the surface 26′ or 27′ of the roll 104 or 102 (see FIG. 3).

An orifice plate support 40 is mounted on the front wall 30, and adjustably supports an orifice plate 42 which extends toward the roll surface 22 or supported web 26 and generally parallel to the coater blade. The orifice plate 42 has a free tip or edge 44 which is juxtaposed to but spaced slightly from the roll surface or web, such that an adjustably sized space or gap 46 between the edge 44 and the moving surface is formed. The gap is relatively small and less than one inch and usually (anywhere from 1/16 to ⅜ of an inch (1.5 to 10 mm) with about 3/16 of an inch (5 mm) being preferred). The gap forms the upstream end of the application zone.

At the two ends of the coater, the spaces between the coater doctor blade 36 and the orifice plate 42 are sealed off in a manner known in the art by flexible edge dams or deckles (not shown), which seal with the upper edges of the wall members 28 and 30 and the orifice plate support 40, the doctor blade 36, the orifice plate 42 and the roll surface or supported web 26, thereby to define a coating material application zone 48 downstream (with reference to coating flow) from the chamber 32 and the metering slot 34.

In operation of the applicator thus far described, coating liquid is introduced under sufficient pressure and in sufficient quantity to substantially completely fill the chamber 32, the metering slot 34 and the application zone 48 defined by the doctor blade 36, the orifice plate 40 and the end dams, to cause a continuous, copious flow of coating material reversely of the direction of web travel through the narrow space or gap 46 defined between the upper end 44 of the orifice plate and the web or roll surface. This forms a liquid seal at the front of the application zone between the edge and the moving web or roll surface and causes the coating liquid to be applied to the web or roll surface in a very narrow transverse band under a constant positive pressure. The copious excess of coating liquid that flows through the orifice gap 46 reversely of the direction of web or roll surface travel forms a non-abrasive liquid seal with the web or roll surface at the upstream (relative to web travel) or forward edge of the coating application zone; causes the coating liquid in the application zone to be maintained under pressure and to be applied to the web or roll surface under pressure; seals off the forward edge of the application zone against entry of air and foreign matter; strips air from the high speed web or roll surface and helps prevent such air from causing streaks or skips in the coating on the web or roll surface; and permits the downstream coater doctor blade 36 to doctor the coating liquid while the liquid is held under pressure. Specifics as to pressures, times of applications, blading or doctoring pressures and/or other operating conditions can be determined from the patents incorporated herein by reference. For example, application times can be from 0.0100 to 0.0016 seconds; application pressures from 0.25 to 2.5 and doctoring pressures to 9 pt; while supply coating flow is reduced 22 to 40% relative to a conventional SDTA. Of course, web speeds for the present invention may be higher say from 3,500 ft./min. or higher say to 5,000 ft./min. or above as previously mentioned.

A doctoring tip 50 of the coater blade 36 is beveled or honed to an angle, which is the operating angle of the blade. The lower end of the blade is clamped in its seat by the pneumatic tube 38, and the bevel is preferably maintained flat or tangential to the web 26 or roll surface at its point of contact, and to this end adjustment means (not shown), but as described in said U.S. Pat. No. 4,250,211 or any other known conventional adjustment means, are provided for adjusting the angular orientation of the coater head or main beam 20 with respect to the web. For example, actuators such as provided by Measurex known as AutoCoat, now Honeywell Precoat Systems could be provided. Likewise, a Roll Flex doctor rod could be provided instead of a blade. In this instance, as shown in FIG. 1, the blade tip 50 is urged or loaded against the roll surface or supported web by a second pneumatic tube 51 mounted in the block 90 on the rear wall member 28, toward the upper end of the blade. The amount, quantity or weight of coating applied to the web or roll surface is influenced by the force of the blade tip against the web or roll surface and by the angle that the tip makes relative to the web.

The applicator is generally referred to as a short dwell time applicator. When used directly on a web, this type applicator avoids saturation of the web with coating material, thereby to prevent the water portion of the coating composition as well as the water solution or dispersible materials contained therein from migrating into the web at a more rapid rate than the pigment, the web (or roll surface in the case if a size press or film coater) is exposed to the coating material in the application zone 48 for only a relatively short time. To this end, the width of the application zone in the direction of web travel, as well as the speed of travel of the web through the zone, are controlled to provide a relatively short dwell time of the web within the zone. However, a difficulty which occasionally is encountered in prior art SDTA's is that, depending upon the nature of the paper web and the coating composition, the coating may fail to fully penetrate and fill voids and valleys in the surface of the web. Additionally, due to the speed of the web, induced coating flow and coating characteristics, vortices can and will form in any free spaces. That is, the larger the free space, the greater the tendency to form vortices in the application zone. It is believed that the formation of vortices can cause streaking of the produced paper.

One way to limit streaking is to limit vortice formations. It is believed limiting free space in the application zone can contribute to reduced vortices and/or streaking. While others have tried this approach, there has not been overwhelming success. It is believed that the manner and way the space is limited and manner and way the coating flow is conducted can have increased success. To help overcome the aforementioned disadvantage, an internal flow member 54 is provided within the application zone 48 for more uniformly applying coating material on the web while the web or moving roll surface is within the zone. The flow member must be and is supported by a holder portion 56, which in turn may be carried between the front wall 30 and the orifice plate support 40 for movement toward and away from the web, thereby to adjust the position of the flow member 54 relative to the web or roll surface. To permit flow through the holder 56, a plurality of slots or holes 58 are provided. These openings should be large enough in flow area not to unduly restrict the flow (say 2-3 times that of the metering gap 34). For example, they could be drilled holes 5/16 to ¾ inch in-diameter spaced say ½ inch apart. They should not unduly weaken the support for the flow member. These holes or openings 58 align with the chamber 32 and supply channel to the application zone.

Here as the flow member 54 is supported off the orifice plate 42, it will move with the same, permitting adjustment of the gap the tip 63 makes with the web or roll surface.

In an alternative construction, the flow member could be supported off of the beam 28, but such might not be adjustable or would require a separate adjusting means.

The flow member 54 and its holder 56 divide the application zone 48 into a leading or upstream (relative to the web) application zone or chamber 60 and a lagging or downstream (relative to the web) application zone or chamber 62, with communication between the upstream and downstream chambers being established at the web or roll surface by passing over the tip 63 of the flow member (which is closely adjacent, 0.032 inches to 0.125 inches (0.81 mm to 3.2 mm), but not touching the web or roll surface) and at the bottom of the flow member through the plurality of openings (or alternatively elongated slots) 58 formed through and transversely of the flow member holder 56.

The flow member 54 is located so that initial flow out of the chamber 32 and metering slot 34 first turns upstream relative to the web (to the left as shown in FIG. 1). To assist this initial turn, a lower extending, directing tip or edge 70 is provided at the bottom of the flow member. After leaving the passage formed by slots or opening 58, the flow encounters a nearly right angle curve 73 and turns upward (as shown in FIG. 1) to cause the flow to then head directly up toward the web (or roll surface). Again, this passage (formed between walls 74 and 76) tapers or narrows as it flows toward the web to provide a secondary metering slot to further help diffuse any nonuniform cross web distribution, such as caused by passing through the plurality of the slots or opening 58. The curved surface 73, 74 also helps cause any air bubbles in the coating to migrate toward the inside of the curve (toward wall 76), and thus away from the moving web (or roll surface) to help keep air bubble imperfections off the web (or roll surface). This curved surface 73, 74 works in a similar manner to the curved surface disclosed in U.S. Pat. No. 5,436,030, which is incorporated herein by reference. It is also important to keep the velocity in this turn high enough and the viscosity of the coating low enough to facilitate such bubble migration. Velocities of 100 to 1000 feet/minute and viscosities of 1500 to 8000 centipoise (cps) Brookfield at 20 rpm would seem suitable, with about 300-700 feet/minute and 2000-4000 cps preferred.

As is shown, the distance between the surface 74 and flow member 54 can be independently adjusted to provide a desired gap. To accomplish this, the adjustment mechanism comprising the hinge portion 80 and adjustment and retention screws 82 and 84 are provided. By turning screw 82 downward in its threaded bore 86, the distance between 74 and 54 may be closed. By turning the screw in the opposite direction, it may be opened, the hinge section springing it upward. Tightening or loosening the locking screw 84 in its threaded bore 88 holds the surface 74 and tip 44 in position. It of course needs to be loosened to make an adjustment to reduce the distance between 74 and 54.

Because of the present invention, the flow to the coater of the present invention is between 1-1½ gallons per minute per inch of width. Normal SDTA's require 1.75-2.2 gpm/inch of width. Thus the input flow is different from prior art coaters having flow members therein in that it is considerably smaller, resulting in smaller size coating supply components and lower installation and operating costs.

The flow then moves up a sloped surface 78 of the flow member which also converges toward the web or roll surface in the downstream (web direction) to cause yet another metering effect to provide more uniform distribution of the coating across the web. Again, this tapered surface is different from many prior art devices which showed surfaces, more or less parallel to the web which would effect undesirable and increased shearing which can set up and may increase unwanted vortex formation. The tapering surfaces of the web or roll and 78 in the present invention help minimize any shearing effect in the application zone and thus minimizing or eliminate formation of vortices and/or streaking. The flow then moves across the doctor or tip 63. Much of the coating flow is forced downward by the momentum provided by the moving web or roll surface down to return and merge with the incoming coating flow from slot 34. Other portions of the coating are carried by the web or roll surface to the doctor 36, in this instance a blade, wherein part is doctored off and some passes beneath the tip 63 to be applied to the web or roll surface.

In operation of the applicator with the internal flow member 54 and its holder 56, coating liquid is supplied under sufficient pressure and in sufficient quantity to substantially fill the chamber 32, the metering slot 34 and the upstream and downstream portions 60 and 62 of the application chamber 48, thereby to substantially fill the application chamber with a supply of coating material for application on the surface of the web or roll.

Thus, as the paper web or roll surface 26 travels through the application zone in the direction indicated by the arrow 24, it receives an initial coating on its surface at or before the gap 44 within the upstream application chamber 60 which coating is partially metered by the internal flow member 54 as the web or roll surface moves toward and by the tip 63 (which does not contact the web or roll surface) from the upstream chamber 60 and into the downstream chamber 62. Consequently, by the time the web or roll surface enters the downstream application zone 62, it has already been initially coated and partially metered. Then, within the downstream application chamber, the coating is doctored by the coater blade 36 to the desired coating weight as the web or roll surface exits from the downstream zone.

Because of the internal flow member 54, during the relatively limited time of passage through the application zone 48, coating material is applied and partially metered on the web or roll surface. The internal flow modifier meters the initial coating applied in the upstream application chamber 62, and produces pressure and limits shear on the coating material which helps to improve coating of the web or roll surface. Subsequently, the coater blade 36 meters and levels the film of fresh coating on the previously coated and partially pre-metered web or roll surface to complete the coating process. This operation is believed, will produce a very uniform and smooth coated surface on the web or roll surface without streaking at higher operating speeds, and if desired, a somewhat denser coating layer may be provided on the web without the disadvantage of subjecting the web to a prolonged dwell or soak time. The use of the flow member also is believed to eliminate or reduce the likelihood of the formation of vortices and streaking. The placement of the flow member and the use of the several tapering surfaces to provide additional cross machine metering and pressure application also help provide a more uniform coating. The tapered surfaces and secondary metering actions are particularly important in eliminating any nonuniform distribution. Also, the limits on shearing and additional pressure provided by the top tapered surface of the flow member with the moving surface (web or roll) helps eliminate vortices and provides more uniform coating application.

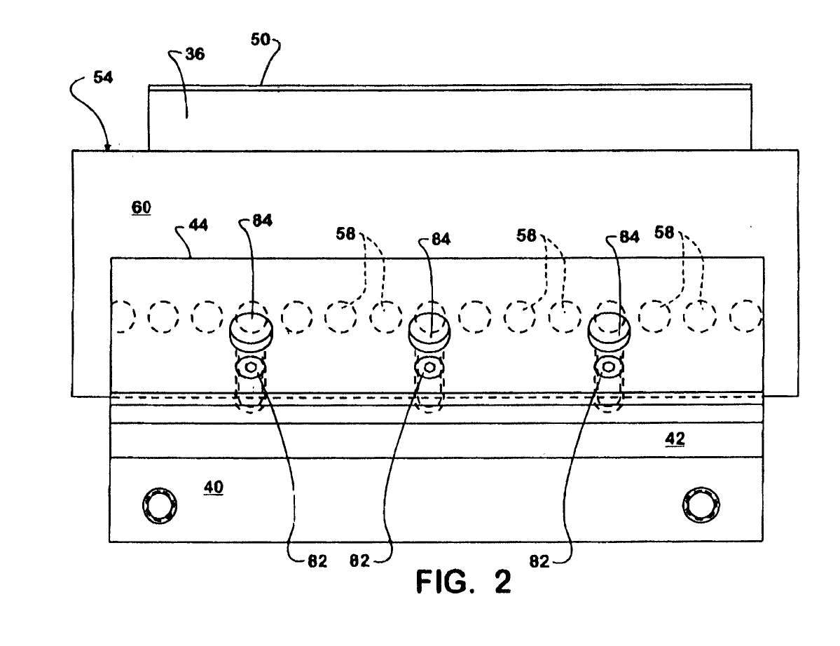

Referring to FIG. 3, a film coater 100 is shown utilizing the present invention. The film coater has two rotating rolls 102 and 104 providing a nip 106 between the two rolls 102 and 104. A web 108 moves between the two rolls 102 and 104 and coats the web with coating material put on the rolls by the applicators 110 and 112 of the present invention. These applicators 110 and 112 are similar to the applicator 18 shown in FIGS. 1 and 2. The applicator 112 is shown fitted with a doctor blade 114, while the applicator 110 is shown fitted with a doctor roll 116 rotatably mounted in a doctor roll holder 118. It should be understood that any of applicators 18, 110 or 112 could have either a blade or roll type doctor.

It should be understood that this coater could also be used in conjunction with a size press arrangement wherein an applicator like the present invention applies coating directly to a web moving on a backing roll, while a second applicator applies coating to the moving roll surface of the backing roll which is then subsequently transferred into the opposite side of the web.

While the invention has been described in conjunction with a moving surface, that surface can be a moving web, as in a short dwell coater, or a moving roll surface as in a film coater.

While several embodiments of the invention have been described, various modifications, other embodiments and equivalent elements and steps thereof may be devised by one skilled in the art without departing from the spirit and scope of the invention, as defined in the appended claims.

What is claimed:

1. A method for applying a coating to a moving surface, comprising the steps of supplying coating under pressure to a coater head, causing the coating to flow downstream against the direction of moving surface travel, causing the coating to flow toward the moving surface, applying some of the coating to the surface, the other of the coating turning away from the moving surface toward the local where the coating first flowed in a direction downstream of the moving surface, merging the returning coating with the coating flowing in a downstream moving direction, directing the coating applied to the moving surface toward a doctor, removing some of the coating applied to the moving surface with the doctor and permitting the remainder of the coating of a desired coat weight to pass by the doctor, whereby the coating applied to the moving surface has a reduced tendency to form vortices therein and streaking.

2. The method as in claim 1, wherein said moving surface is a moving web of paper.

3. The process as in claim 1, wherein said moving surface is a roll, said roll being adapted to transfer some of the coating to a moving web of paper.

4. The method of claim 1, wherein the step of flowing the coating downstream of the direction of moving surface travel, and returning the other of said coating to said local, comprises the step of causing the coating to turn around a flow member.

5. The method as in claim 4, wherein said moving surface is a moving web of paper.

6. The method as in claim 4, wherein said moving surface is a roll, said roll being adapted to transfer some of the coating to a moving web of paper.

7. The method of claim 1, providing an additional step of causing an overflow of coating from that headed toward the moving surface to wet the moving surface before it enters the coater.

8. The method as in claim 7, wherein said moving surface is a moving web of paper.

9. The method as in claim 7, wherein said moving surface is a roll, said roll being adapted to transfer some of the coating to a moving web of paper.

10. The method of claim 7, wherein said step of causing an overflow includes the step of adjusting the amount of overflow to a desired level.

11. The method as in claim 10, wherein said moving surface is a moving web of paper.

12. The method as in claim 10, wherein said moving surface is a roll, said roll being adapted to transfer some of the coating to a moving web of paper.

13. The method of claim 1, wherein the step of doctoring comprising blading the coating with a doctor blade.

14. The method as in claim 13, wherein said moving surface is a moving web of paper.

15. The method as in claim 13, wherein said moving surface is a roll, said roll being adapted to transfer some of the coating to a moving web of paper.

16. The method of claim 13, wherein the step of doctoring comprises blading the coating with a bent blade.

17. The method as in claim 16, wherein said moving surface is a moving web of paper.

18. The method as in claim 16, wherein said moving surface is a roll, said roll being adapted to transfer some of the coating to a moving web of paper.

19. The method of claim 13, wherein the step of doctoring comprises the step of doctoring the coating with a flexible blade.

20. The method as in claim 19, wherein said moving surface is a moving web of paper.

21. The method as in claim 19, wherein said moving surface is a roll, said roll being adapted to transfer some of the coating to a moving web of paper.

22. The method of claim 13, wherein the step of doctoring comprises doctoring the coating with a doctor roll.

23. The method as in claim 22, wherein said moving surface is a moving web of paper.

24. The method as in claim 22, wherein said moving surface is a roll, said roll being adapted to transfer some of the coating to a moving web of paper.

25. The method of claim 22, wherein the step of doctoring comprising doctoring the coating with a grooved doctor roll.

26. The method as in claim 25, wherein said moving surface is a moving web of paper.

27. The method as in claim 25, wherein said moving surface is a roll, said roll being adapted to transfer some of the coating to a moving web of paper.

28. The method of claim 1, wherein the step of causing the coating to flow upstream of the direction of moving surface travel includes the step of passing the coating by supports for locating a flow member.

29. The method as in claim 28, wherein said moving surface is a moving web of paper.

30. The method as in claim 28, wherein said moving surface is a roll, said roll being adapted to transfer some of the coating to a moving web of paper.

31. The method of claim 28, wherein the step of claim 26 comprising passing the coating through a plurality of openings extending in the coater across the width of the moving surface.

32. The method as in claim 31, wherein said moving surface is a moving web of paper.

33. The method as in claim 31, wherein said moving surface is a roll, said roll being adapted to transfer some of the coating to a moving web of paper.

34. A coater for applying a coating to a moving surface, comprising a coater head for supplying coating under pressure to the moving surface, said coater having a flow path for causing the coating to flow downstream against the direction of moving surface travel, said flow path turning toward the moving surface for causing the coating to flow toward the moving surface, said coater head having an application zone adjacent the moving surface for applying at least some of the coating to the moving surface, the coater head having a return path flowing from the application zone toward the flow path where the coating first flowed in a direction downstream of the moving surface, the return path merging into the flow path and the returning coating flowing in a downstream direction away from the moving surface, a doctor at the rear of the application zone for removing some of the coating applied to the moving surfaces with the doctor and permitting the remainder of the coating of a desired coat weight to pass by the doctor, whereby the coater can apply coating to the moving surface with a reduced tendency to form vortices therein and streaking.

35. The coater of claim 34, wherein said moving surface is a moving web of paper.

36. The coater of claim 34, wherein said moving surface is a roll, said roll being adapted to transfer some of the coating to a moving web of paper.

37. The coater of claim 34, further comprising a flow member generally surrounded by the flow path, the application zone and the return path, whereby the coating can flow around said flow member.

38. The coater of claim 37, wherein said moving surface is a moving web of paper.

39. The coater or claim 37, wherein said moving surface is a roll, said roll being adapted to transfer some of the coating to a moving web of paper.

40. The coater of claim 34, comprising a spaced gap between the moving surface and coater head for causing an overflow of coating from that headed toward the moving surface to wet the moving surface before it enters the coater.

41. The coater of claim 40, where said moving surface is a moving web of paper.

42. The coater of claim 40, wherein said moving surface is a roll, said roll being adapted to transfer some of the coating to a moving web of paper.

43. The coater of claim 38, including means for adjusting the amount of overflow through the gap to a desired level.

44. The coater of claim 43, wherein said moving surface is a moving web of paper.

45. The coater of claim 43, wherein said moving surface is a roll, said roll being adapted to transfer some of the coating to a moving web of paper.

46. The coater of claim 34, wherein said doctor comprises a doctor blade for blading the coating.

47. The coater of claim 46, wherein said moving surface is a moving web of paper.

48. The coater of claim 46, wherein said moving surface is a roll, said roll being adapted to transfer some of the coating to a moving web of paper.

49. The coater of claim 46, wherein said doctor comprises a bent blade for blading the coating.

50. The coater of claim 49, wherein said moving surface is a moving web of paper.

51. The coater of claim 49, wherein said moving surface is a roll, said roll being adapted to transfer some of the coating to a moving web of paper.

52. The coater of claim 46, wherein said doctor comprises a flexible blade for blading the coating.

53. The coater of claim 52, wherein said moving surface is a moving web of paper.

54. The coater of claim 52, wherein said moving surface is a roll, said roll being adapted to transfer some of the coating to a moving web.

55. The coater of claim 34, wherein said doctor comprises a doctor roll for doctoring the coating.

56. The coater of claim 55, wherein said moving surface is a moving web of paper.

57. The coater of claim 55, wherein said moving surface is a roll, said roll being adapted to transfer some of the coating to a moving web of paper.

58. The coater of claim 55, wherein said doctor roll includes one or more grooves therein.

59. The coater of claim 58, wherein said moving surface is a moving web of paper.

60. The coater of claim 58, wherein said moving surface is a roll, said roll being adapted to transfer some of the coating to a moving web of paper.

61. The coater of claim 34, including supports for locating a flow member in said application zone, said support being attached to said coater head.

62. The coater of claim 61, wherein said moving surface is a moving web of paper.

63. The coater of claim 61, wherein said moving surface is a roll, said roll being adapted to transfer some of the coating to a moving web of paper.

64. The coater of claim 61, wherein said support includes a plurality of openings extending in the coater across the width of the moving surface, passing the coating therethrough and permitting coating flow around said flow member.

65. The coater of claim 64, wherein said moving surface is a moving web of paper.

66. The coater of claim 64, wherein said moving surface is a roll, said roll being adapted to transfer some of the coating to a moving web of paper.

67. A method for applying a coating to a moving surface, comprising the steps of supplying coating under pressure to a coater head, causing the coating to flow from downstream against the direction of moving surface travel, causing the coating to flow toward the moving surface, causing an overflow of coating from that headed toward the moving surface to wet the moving surface before it enters the coater, adjusting the amount of overflow to a desired level, applying some of the coating to the surface, flowing the coating downstream of the direction of web travel, and returning the same applied coating to said local, comprises the step of causing the coating to turn around a flow member, the other of the coating turning away from the moving surface toward said local where the coating first flowed in a direction downstream of the moving surface, merging the returning coating with the coating flowing in a downstream moving direction, causing the coating to flow upstream of the direction of web travel includes the step of passing the coating by supports for locating a flow member, directing the coating applied to the moving surface toward a doctor, removing some of the coating applied to the moving surface with the doctor and letting the remainder of the coating of a desired coat weight pass by the doctor, whereby the coating applied to the moving surface has a reduced tendency to form vortices therein and streaking.

68. The method of claim 67, wherein the step of doctoring comprising blading the coating with a doctor blade.

69. The method of claim 64, wherein the step of doctoring comprises blading the coating with a bent blade.

70. The method of claim 68, wherein the step of doctoring comprises the step of doctoring the coating with a flexible blade.

71. The method of claim 68, wherein the step of doctoring comprises doctoring the coating with a doctor roll.

72. The method of claim 71, wherein the step of doctoring comprising doctoring the coating with a grooved doctor roll.

73. The method of claim 67, wherein comprising passing the coating through a plurality of openings extending in the coater across the width of the moving surface.

74. The method of claim 73, wherein said moving surface is a moving web of paper.

75. The method of claim 73, wherein said moving surface is a roll, said roll being adapted to transfer some of the coating to a moving web of paper.

76. The method of claim 67, wherein said moving surface is a moving web of paper.

77. The method of claim 67, wherein said moving surface is a roll, said roll being adapted to transfer some of the coating to a moving web of paper.

78. A coater for applying a coating to a moving surface, comprising a coater head for supplying coating under pressure to the moving surface, said coater head having a flow path for causing the coating to flow downstream against the direction of moving surface travel, said flow path turning toward the moving surface for causing the coating to flow toward the moving surface, said coater head having an application zone adjacent the moving surface for applying at least some of the coating to the moving surface, the coater head having a return path flowing from the application zone toward the flow path where the coating first flowed in a direction downstream of the moving surface, the return path merging into the flow path and the returning coating with the coating flowing in a downstream moving surface direction, a flow member generally surrounded by the flow path, the application zone and the return path, whereby the coating can flow around said flow member, a spaced gap between the moving surface and coater head for permitting an overflow of coating from that headed toward the moving surface to wet the moving surface as it enters the coater, means for adjusting the amount of overflow through the gap to a desired level, supports for locating a flow member in said application zone, said support being attached with said coater head, a doctor at the rear of the application zone for removing some of the coating applied to the moving surface with the doctor and letting the remainder of the coating of a desired coater weight pass by the doctor, whereby the coater can apply coating to the moving web with a reduced tendency to form vortices therein and streaking.

79. The coater of claim 78, wherein said doctor comprises a doctor blade for blading the coating.

80. The coater of claim 79, wherein said doctor comprises a bent blade for blading the coating.

81. The coater of claim 79, wherein said doctor comprises a flexible blade for blading the coating.

82. The coater of claim 79, wherein said doctor comprises a doctor roll for doctoring the coating.

83. The coater of claim 82, wherein said doctor roll includes one or more grooves therein.

84. The coater of claim 78, wherein said support includes a plurality of openings extending in the coater across the width of the moving surface, passing the coating therethrough and around said flow member.

85. The coater of claim 84, wherein said moving surface is a moving web of paper.

86. The coater of claim 84, wherein said moving surface is a roll, said roll being adapted to transfer some of the coating to a moving web of paper.

87. The coater of claim 78, wherein said moving surface is a moving web of paper.

88. The coater of claim 78, wherein said moving surface is a roll, said roll being adapted to transfer some of the coating to a moving web of paper.
